(19) United States
(12) Patent Application Publication
(10) Pub. No.: US 2014/0240646 A1
(43) Pub. Date: Aug. 28, 2014

(54) LIQUID CRYSTAL DISPLAY DEVICE AND MANUFACTURING METHOD THEREOF

(71) Applicant: Xiaolong Ma, Shenzhen (CN)

(72) Inventor: Xiaolong Ma, Shenzhen (CN)

(73) Assignee: Shenzhen China Star Optoelectronics Technology Co. Ltd., Shenzhen (CN)

(21) Appl. No.: 13/581,476

(22) PCT Filed: Jul. 2, 2012
(86) PCT No.: PCT/CN12/78011

§ 371 Date: Aug. 28, 2012

(30) Foreign Application Priority Data
Jun. 15, 2012 (CN) 201210199272.X

(51) Int. Cl. G02F 1/1337; G02F 1/1333

(52) U.S. Cl. CPC G02F 1/133711; G02F 1/1333
USPC 349/96; 445/24

(57) ABSTRACT

A liquid crystal display (LCD) device is disclosed herein. The LCD device comprises a backlight unit, a first polarizing plate, an array substrate, a first liquid crystal layer, a color filter substrate and a second polarizing plate, all of which are sequentially overlapped and assembled in integral. Alignment directions of liquid crystal molecules located in the first surface of the first liquid crystal layer are vertical to alignment directions of liquid crystal molecules located in the second surface of the first liquid crystal layer. The LCP film is disposed between the first polarizing plate and the array substrate. A manufacturing method of the LCD device is further disclosed herein.

### TECHNICAL FIELD OF THE INVENTION

The present invention relates to the filed in a liquid crystal display technology, and more particularly to, a liquid crystal display device and a manufacturing method thereof.

### BACKGROUND OF THE INVENTION

A traditional LCD (liquid crystal display) device might comprise a backlight, a first polarizing plate, an array substrate, a liquid crystal layer, a color filter substrate and a second polarizing plate, all of which are sequentially overlapped in integral assembly. In the LCD device, a polarization direction of the first polarizing plate is vertical to a polarization direction of the second polarizing plate. The LCD device controls the moving directions of the liquid crystal molecules in liquid crystal layer to vary the polarization state of the lights therethrough by applying voltage on the liquid crystal molecules so that the lights polarized by and transmitted from the first polarizing plate can pass through the second polarizing plate to accomplish an image display.

The traditional LCD devices are classified as the following several types of: a TN (Twisted Nematic) mode, a VA (Vertical Alignment) mode, an IPS (In Panel Switching) mode and so forth. By a special liquid crystal molecules alignment, the TN mode LCD device has an advantage of faster responses over the other two modes. The advantage offers great outstanding under the condition of 3D images displaying of the LCD device which has superior requirements on the response time.

On a static status of the TN mode, the alignment directions of the liquid crystal molecules of LCD device are parallel to a direction where the array substrate and the color filter substrate are expended, and the liquid crystal molecules round a normal line direction to the above-mentioned substrates and are successively twisted in its specific angle. Due to the rotary polarization effect, the polarized lights emerged from the first polarizing plate are rotated to 90 degrees by following the liquid crystal molecules and then are incident on the second polarizing plates in a manner that the polarization direction of the polarized lights are parallel to a direction where a transmission axis of the second polarizing plate is extended, so that the lights pass through the first polarizing plate and the second polarizing plate to accomplish the image display. The TN mode LCD device displays normally white without voltage applied thereon and TN mode LCD device displays dark state with voltage applied thereon to a manner that most of the liquid crystal molecules in liquid crystal layer are aligned vertically to the direction where the array substrate and the color filter substrate are extended,. Due to an anchoring force of the alignment layer, the alignment directions of the liquid crystal molecules neighboring to the alignment layer are still parallel to the direction where the array substrate and the color filter substrate are extended. This would evoke an optical retardation such that the light leakage will also be caused. The TN mode LCD device displays worse contrast characteristic over other modes because of the light leakage in the dark state.

### SUMMARY OF THE INVENTION

An objective of the present invention is to provide a LCD device which can avoid a light leakage phenomenon occurring on the LCD device, raise the contrast characteristic upon displaying, and retain the advantage of fast response as a TN mode LCD device provided, simultaneously.

To solve the above-mentioned problem, the present invention provides a liquid crystal display (LCD) device, the LCD device comprises a backlight unit, a first polarizing plate, an array substrate, a first liquid crystal layer, a color filter substrate and a second polarizing plate, all of which are sequentially overlapped and assembled in integral. The first liquid crystal layer comprises a first surface and a second surface wherein the alignment directions of liquid crystal molecules located in the first surface are vertical to the alignment directions of liquid crystal molecules located in the second surface. The LCD device further comprises a liquid crystal polymer (LCP) film disposed between the first polarizing plate and the array substrate and having a second liquid crystal layer disposed therein. The alignment directions of the liquid crystal molecules located in the second liquid crystal layer are parallel to a plane where the LCP film is located. The second liquid crystal layer comprises a third surface and a fourth surface wherein alignment directions of liquid crystal molecules located in the third surface are vertical to alignment directions of liquid crystal molecules located in the fourth surface. The second liquid crystal layer has the same phase difference with the first liquid crystal layer. The liquid crystal molecules located in the third surface has the same alignment direction and the liquid crystal molecules located in the fourth surface has the same alignment direction wherein the alignment direction of the liquid crystal molecules is a direction where the major axes of the liquid crystals are directed.

In the above-mentioned LCD device, the third surface of the second liquid crystal layer faces to the first liquid crystal layer.

In the above-mentioned LCD device, the fourth surface of the second liquid crystal layer faces to the first polarizing plate.

In the above-mentioned LCD device, the alignment directions of the liquid crystal molecules located in the fourth surface of the second liquid crystal layer are parallel to a direction where a transmission axis of the first polarizing plate is located.

In the above-mentioned LCD device, alignment directions of liquid crystal molecules located in the third surface of the second liquid crystal layer are parallel to alignment directions of liquid crystal molecules located in the second surface of the first liquid crystal layer.

An another objective of the present invention is to provide a LCD device which can avoid a light leakage phenomenon occurring on the LCD device, raise the contrast characteristic upon displaying and retain the advantage of fast response as a TN mode LCD device provided, simultaneously.

To solve the above-mentioned problem, the present invention provides an LCD device comprising a backlight unit, a first polarizing plate, an array substrate, a first liquid crystal layer, a color filter substrate and a second polarizing plate, all of which are sequentially overlapped and assembled in integral. The first liquid crystal layer comprises a first surface and a second surface, wherein alignment directions of liquid crystal molecules located in the first surface are vertical to alignment directions of liquid crystal molecules located in the second surface. The LCD device further comprises a liquid crystal polymer (LCP) film disposed between the first polarizing plate and the array substrate or between the color filter substrate and the second polarizing plate.

In the above-mentioned LCD device, the LCP film has a second liquid crystal layer disposed therein, alignment directions of liquid crystal molecules located in the second liquid crystal layer are parallel to a plane where the LCP film is located, the second liquid crystal layer comprises a third surface and a fourth surface, and alignment directions of liquid crystal molecules located in the third surface are vertical to alignment directions of liquid crystal molecules located in the fourth surface.

In the above-mentioned LCD device, the second liquid crystal layer has the same phase difference with the first liquid crystal layer.

In the above-mentioned LCD device, if the LCP film is disposed between the first polarizing plate and the array substrate, the third surface of the second liquid crystal layer faces to the first liquid crystal layer, the fourth surface of the second liquid crystal layer faces to the first polarizing plate, the alignment directions of the liquid crystal molecules located in the fourth surface of the second liquid crystal layer are parallel to a direction where a transmission axis of the first polarizing plate is located, and alignment directions of liquid crystal molecules located in the third surface of the second liquid crystal layer are parallel to alignment directions of liquid crystal molecules located in the second surface of the first liquid crystal layer.

In the above-mentioned LCD device, if the LCP film is disposed between the first polarizing plate and the array substrate, the third surface of the second liquid crystal layer faces to the first liquid crystal layer, the fourth surface of the second liquid crystal layer faces to the first polarizing plate, alignment directions of liquid crystal molecules located in the fourth surface of the second liquid crystal layer are parallel to a direction where a transmission axis of the first polarizing plate is located, and the alignment directions of the liquid crystal molecules located in the third surface of the second liquid crystal layer are parallel to the alignment directions of the liquid crystal molecules located in the second surface of the first liquid crystal layer.

In the above-mentioned LCD device, if the LCP film is disposed between the color filter substrate and the second polarizing plate, the third surface of the second liquid crystal layer faces to the second polarizing plate, the fourth surface of the second liquid crystal layer faces to the liquid crystal layer, the alignment directions of the liquid crystal molecules located in the fourth surface of the second liquid crystal layer are parallel to a direction where a transmission axis of the first polarizing plate is located, and alignment directions of liquid crystal molecules located in the fourth surface of the second liquid crystal layer are parallel to alignment directions of liquid crystal molecules located in the first surface of the first liquid crystal layer.

In the above-mentioned LCD device, if the LCP film is disposed between the color filter substrate and the second polarizing plate, the third surface of the second liquid crystal layer faces to the second polarizing plate, the fourth surface of the second liquid crystal layer faces to the liquid crystal layer, the alignment directions of the liquid crystal molecules located in the fourth surface of the second liquid crystal layer are parallel to a direction where a transmission axis of the first polarizing plate is located, and the alignment directions of the liquid crystal molecules located in the fourth surface of the second liquid crystal layer are parallel to the alignment directions of the liquid crystal molecules located in the first surface of the first liquid crystal layer.

An another objective of the present invention is to provide a LCD device which can avoid a light leakage phenomenon occurring on the LCD device, raise the contrast characteristic upon displaying and retain the advantage of fast response as a TN mode LCD device provided, simultaneously TN mode LCD device.

To solve the above-mentioned problem, the present invention provides a manufacturing method of LCD device, the LCD device comprises a backlight unit, a first polarizing plate, an array substrate, a first liquid crystal layer, a color filter substrate, and a second polarizing plate, wherein the first liquid crystal layer comprises a first surface and a second surface, alignment directions of liquid crystal molecules located in the first surface are vertical to alignment directions of liquid crystal molecules located in the second surface; and the manufacturing method comprises a step of sequentially overlapping and assembling the backlight, the first polarizing plate, the array substrate, the liquid crystal layer, the color filter substrate and the second polarizing plate in integral, wherein the LCD device further comprises a liquid crystal polymer (LCP), and the manufacturing method further comprises the following steps of: (A) disposing the LCP film between the first polarizing plate and the array substrate; or (B) disposing the LCP film between the color filter substrate and the second polarizing plate.

In the above-mentioned manufacturing method of LCD device, the LCP film has a second liquid crystal layer disposed therein, the alignment directions of the liquid crystal molecules located in the second liquid crystal layer are parallel to a plane where the LCP film is located, the second liquid crystal layer comprises a third surface and a fourth surface, and alignment directions of liquid crystal molecules located in the third surface are vertical to alignment directions of liquid crystal molecules located in the fourth surface.

In the above-mentioned manufacturing method of LCD device, the second liquid crystal layer has the same phase difference with the first liquid crystal layer.

In the above-mentioned manufacturing method of LCD device, if the LCP film is disposed between the first polarizing plate and the array substrate, the manufacturing method further comprises the following steps of: (c1) setting the third surface of the second liquid crystal layer facing to the first liquid crystal layer; (c2) setting the fourth surface of the second liquid crystal layer facing to the first polarizing plate; (c3) setting the alignment directions of the liquid crystal molecules located in the fourth surface of the second liquid crystal layer being parallel to a direction where a transmission axis of the first polarizing plate is located; and (c4) setting the alignment directions of the liquid crystal molecules located in the third surface of the second liquid crystal layer being parallel to the alignment directions of the liquid crystal molecules located in the second surface of the first liquid crystal layer.

In the above-mentioned manufacturing method of LCD device, if the LCP film is disposed between the first polarizing plate and the array substrate, the manufacturing method further comprises the following steps of: (c1) setting the third surface of the second liquid crystal layer facing to the first liquid crystal layer; (c2) setting the fourth surface of the second liquid crystal layer facing to the first polarizing plate; (c3) setting the alignment directions of the liquid crystal molecules located in the fourth surface of the second liquid crystal layer being parallel to a direction where a transmission axis of the first polarizing plate is located; and (c4) setting the alignment directions of the liquid crystal molecules located in the third surface of the second liquid crystal layer being parallel to the alignment directions of the liquid crystal molecules located in the second surface of the first liquid crystal layer.

In the above-mentioned manufacturing method of LCD device, if the LCP film is disposed between the color filter substrate and the second polarizing plate, the manufacturing method further comprises the following steps of: (d1) setting the third surface of the second liquid crystal layer facing to the second polarizing plate; (d2) setting the fourth surface of the second liquid crystal layer facing to the first liquid crystal layer; (d3) setting the alignment directions of the liquid crystal molecules located in the fourth surface of the second liquid crystal layer being parallel to a direction where a transmission axis of the first polarizing plate is located; and (d4) setting the alignment directions of the liquid crystal molecules located in the fourth surface of the second liquid crystal layer being parallel to the alignment directions of the liquid crystal molecules located in the first surface of the first liquid crystal layer.

In the above-mentioned manufacturing method of LCD device, if the

LCP film is disposed between the color filter substrate and the second polarizing plate, the manufacturing method further comprises the following steps of: (d1) setting the third surface of the second liquid crystal layer facing to the second polarizing plate; (d2) setting the fourth surface of the second liquid crystal layer facing to the first liquid crystal layer; (d3) setting the alignment directions of the liquid crystal molecules located in the fourth surface of the second liquid crystal layer being parallel to a direction where a transmission axis of the first polarizing plate is located; and (d4) setting the alignment directions of the liquid crystal molecules located in the fourth surface of the second liquid crystal layer being parallel to the alignment directions of the liquid crystal molecules located in the first surface of the first liquid crystal layer.

Compared with the prior art, because the present invention introduces that the LCP film is disposed between the first polarizing plate and the array substrate or the LCP film is disposed between the color filter substrate and the second polarizing plate, the LCP film 108 of the present invention effects rotary polarization on the polarized light so that the first liquid crystal layer functions on allowing or prohibiting the polarized light passing through the first polarizing plate and the second polarizing plate. This substantially solves the technical problem of light leakage occurring in the TN mode LCD device. Thus, the light leakage phenomenon occurring on the LCD device can be avoided, the contrast characteristic of the LCD device can be raised, and a advantage of faster response as provided by a traditional TN mode LCD device can be retained.

For better understanding of the aforementioned content of the present invention, the preferred embodiments are described in detail in conjunction with the appending figure as follows.

### BRIEF DESCRIPTION OF THE DRAWINGS

FIG. 1 illustrates a state diagram of applying no voltage to the LCD device according to a first embodiment of the present invention;

FIG. 2 illustrates another state diagram of applying voltage to the LCD device according to the first embodiment of the present invention;

FIG. 3 illustrates a state diagram of applying no voltage to the LCD device according to a second embodiment of the present invention;

FIG. 4 illustrates another state diagram of applying voltage to the LCD device according to the second embodiment of the present invention;

FIG. 5 illustrates a flow chart of a method for manufacturing the LCD device according to the first embodiment of the present invention; and

FIG. 6 illustrates a flow chart of a method for manufacturing the LCD device according to the second embodiment of the present invention.

### DETAILED DESCRIPTION OF THE INVENTION

The respective embodiments will be described with reference to the appending drawings as follows, and they are specific embodiments for exemplifying that the present invention is able to be put into practice.

The present invention provides a liquid crystal display (LCD) device, which has both faster response and displaying a dark state under normal conditions, so as to avoid a situation of light leakage phenomenon as occurring in a traditional TN (Twisted Nematic) mode LCD device under a dark state, raise the contrast ratio upon LCD device displaying, and adapt the trends of the higher and higher requirements of responses velocity and contrast ratio of LCD device.

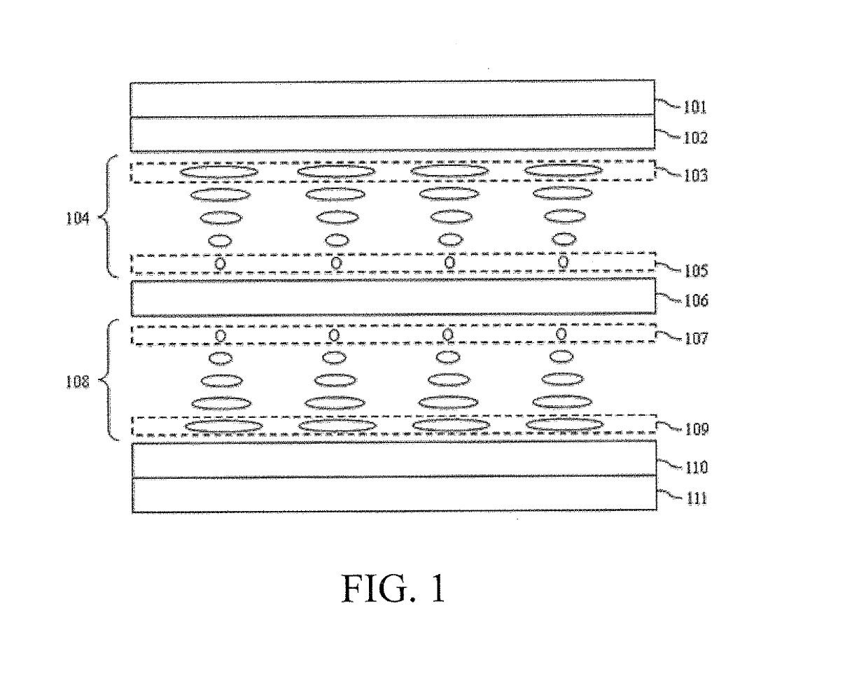

Referring to illustration shown in FIG. 1, FIG. 1 illustrates a state diagram of applying no voltage to the LCD device according to a first embodiment of the present invention. In the present invention, the LCD device comprises a backlight unit 111, a first polarizing plate 110, an array substrate 106, a first liquid crystal layer 104, a color filter substrate 102, and a second polarizing plate 101. The LCD device of the present invention further comprises a liquid crystal polymer (LCP) film 108 which is disposed between the first polarizing plate 110 and the array substrate 106. The LCP film 108 has a number of liquid crystal molecules therein which is defined as a second liquid crystal layer. The alignment directions of the liquid crystal molecules (i.e. the directions where major axes of the liquid crystal molecules are located) located in the second liquid crystal layer are parallel to a plane where the LCP film 108 is located. The second liquid crystal layer has two surfaces, including an upper surface and a lower surface, both which are defined as a third surface 107 and a fourth surface 109, respectively, wherein alignment directions of liquid crystal molecules (i.e. the major axis directions of the liquid crystal molecules) located in the third surface 107 are the same alignment directions of liquid crystal molecules (i.e. the major axis direction of the liquid crystal molecules) located in the fourth surface 109 are the same, and the alignment directions of the liquid crystal molecules located in the third surface 107 are vertical to the alignment directions of the liquid crystal molecules located in the fourth surface 109. There are other liquid crystal molecules still existing between the third surface 107 and the fourth surface 109 of the second liquid crystal layer. The liquid crystal molecules located in the second liquid crystal layer are gradually rotated with, a predetermined angle along a normal line direction of the liquid crystal polymer film 108 from the third surface 107 to the fourth surface 109. That is, the liquid crystal molecules located in the second liquid crystal layer are gradually rotated from zero-degree angle to 90-degree angle along the normal line direction of the liquid crystal polymer film 108 from the third surface 107 to the fourth surface 109. The first liquid crystal layer has the same phase difference with the second liquid crystal layer so that the LCD device of the present invention displays dark under a normal condition so as to avoid the situation of light leakage. The positional relationships among the LCP film 108, the first polarizing plate 110 and the array substrate 106 are as follows: the third surface 107 of the second liquid crystal layer (of the LCP film 108) faces to the first liquid crystal layer 104, the fourth surface 109 of the second liquid crystal layer faces to the first polarizing plate 110, the alignment directions of the liquid crystal molecules (i.e. the major axis direction of the liquid crystal molecules) located in the fourth surface 109 of the second liquid crystal layer are parallel to a direction where a transmission axis of the first polarizing plate 110 is located, and the alignment directions of the liquid crystal molecules located in the third surface 107 of the second liquid crystal layer are parallel to the alignment directions of the liquid crystal molecules located in the second surface 105 of the first liquid crystal layer 104.

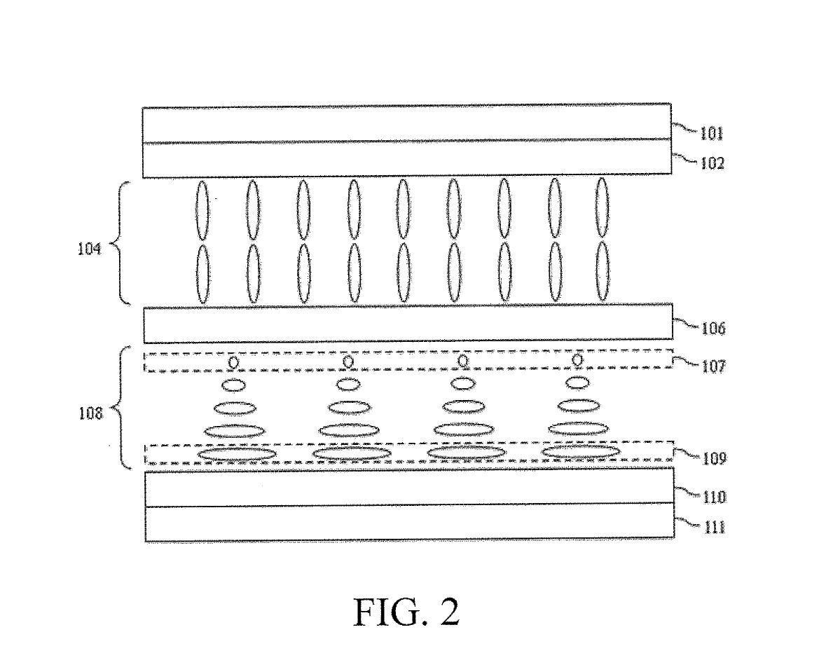

Referring to illustration shown in FIG. 2, FIG. 2 illustrates another state diagram of applying voltage to the LCD device according to the first embodiment of the present invention. In the LCD device of the present invention, when the array substrate 106 applies voltage on the liquid crystal molecules located in the first liquid crystal layer 104, the liquid crystal molecules located in the first liquid crystal layer 104 will be rotated to a manner of being vertical to the array substrate 106 and the color filter substrate 102. Because of the rotary polarization of the LCP film 108, when the polarized light emerged from the first polarizing plate 110 to the first liquid crystal layer 104, the polarized direction of the polarized light are rotated to 90 degrees. The first liquid crystal layer 104 can not effect the rotary polarization on the polarized light incident thereinto. Thus, after passing through the first liquid crystal layer 104 and the color filter substrate 102, the polarized light incident into the second polarizing plate 101 has a polarized direction parallel to the direction where the transmission axis of the first polarizing plate 110 is located so that the light can pass through the first polarizing plate 110 and the second polarizing plate 101.

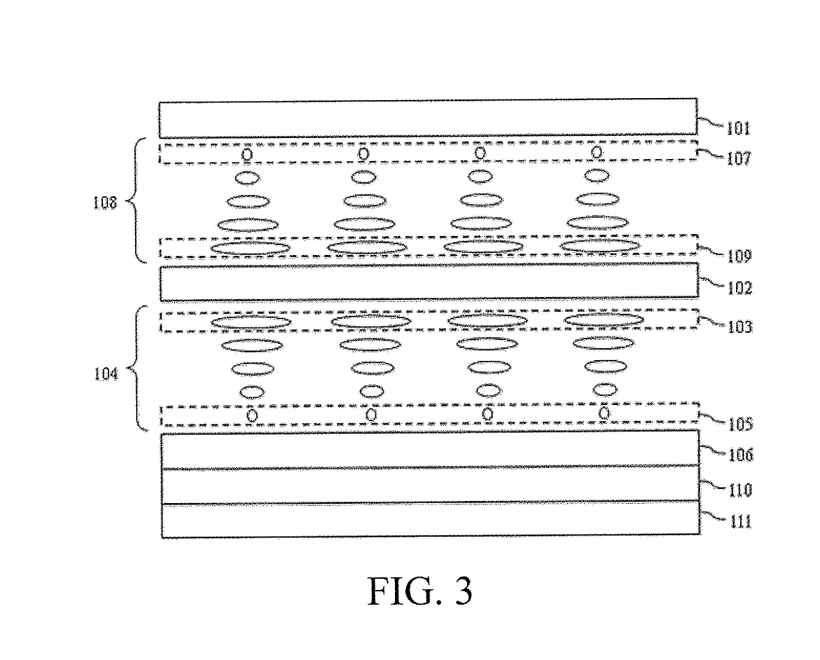

Referring to illustration shown in FIG. 3, FIG. 3 illustrates a state diagram of applying no voltage to the LCD device according to a second embodiment of the present invention. The LCD device of the present invention further comprises a liquid crystal polymer (LCP) film 108 which is disposed between the color filter substrate 102 and the second polarizing plate 101. The LCP film 108 comprises a number of liquid crystal molecules which is defined as a second liquid crystal layer, wherein the alignment directions of the liquid crystal molecules (i.e. the major axis direction of the liquid crystal molecules) located in the second liquid crystal layer are parallel to the plane where the LCP film 108 is located. The second liquid crystal layer has two surfaces, including an upper surface and a lower surface, both which are defined as a third surface 107 and a fourth surface 109, respectively, wherein the alignment directions of the liquid crystal molecules (i.e. the major axis direction of the liquid crystal molecules) located in the third surface 107 are the same, the alignment directions of the liquid crystal molecules (i.e. the major axis direction of the liquid crystal molecules) located in the fourth surface 109 are the same, and the alignment directions of the liquid crystal molecules located in the third surface 107 are vertical to the alignment directions of the liquid crystal molecules located in the fourth surface 109. There are other liquid crystal molecules still existing between the third surface 107 and the fourth surface 109 of the second liquid crystal layer. The liquid crystal molecules located in the second liquid crystal layer are gradually rotated with a predetermined angle along a normal line direction of the liquid crystal polymer film 108 from the third surface 107 to the fourth surface 109. That is, the liquid crystal molecules located in the second liquid crystal layer are gradually rotated from zero-degree angle to 90-degree angle along the normal line direction of the liquid crystal polymer film 108 from the third surface 107 to the fourth surface 109. The first liquid crystal layer have the same phase difference with the second liquid crystal layer so that the LCD device of the present invention displays dark under a normal condition to avoid the situation of light leakage. The positional relationships among the LCP film 108, the color filter substrate 102 and the second polarizing plate 101 are as follows: the third surface 107 of the second liquid crystal layer (of the LCP film 108) faces to the second polarizing plate 101, and the fourth surface 109 of the second liquid crystal layer faces to the first liquid crystal layer 104. The alignment directions of the liquid crystal molecules (i.e. the major axis direction of the liquid crystal molecules) located in the fourth surface 109 of the second liquid crystal layer are parallel to the alignment directions of the liquid crystal molecules located in a first surface 103 of the first liquid crystal layer 104, and the alignment directions of the liquid crystal molecules located in the third surface 107 of the second liquid crystal layer are parallel to a direction which a transmission axis of the second polarizing plate 101 is located.

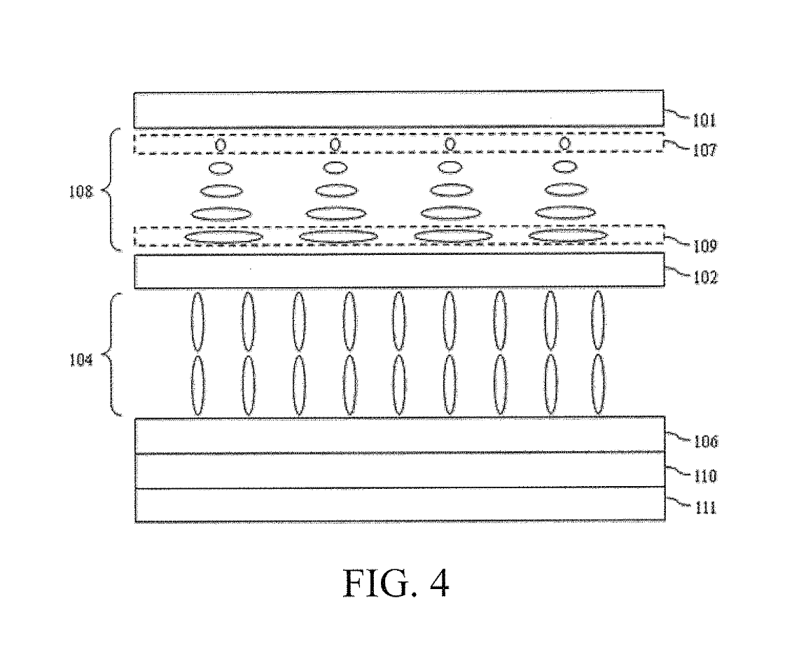

Referring to illustration shown in FIG. 4, FIG. 4 illustrates another state diagram of applying voltage to the LCD device according to the second embodiment of the present invention. In the LCD device of the present invention when the array substrate 106 applies voltage to the liquid crystal molecules located in the first liquid crystal layer 104, the liquid crystal molecules located in the first liquid crystal layer 104 will be rotated to a manner of being vertical to the array substrate 106 and the color filter substrate 102. The polarized lights are transmitted from the first polarizing plate 110 into the first liquid crystal layer 104 wherein the polarization directions of the polarized lights are parallel to the alignment directions of the liquid crystal molecules located in the fourth surface 109 of the LCP film 108 so that the first liquid crystal layer 104 can not effect the rotary polarization on the transmitted polarized light incident into the first liquid crystal layer 104. The polarized directions of the polarized lights will be rotated to 90 degrees when the polarized lights emerged from the first polarizing plate 110 are incident on the second liquid crystal layer because of the rotary polarization effect of the LCP film 108. Thus, the polarized directions of the polarized lights are parallel to the direction where the transmission axis of the second polarizing plate 101 is located so that the lights can pass through the first polarizing plate 110 and the second polarizing plate 101.

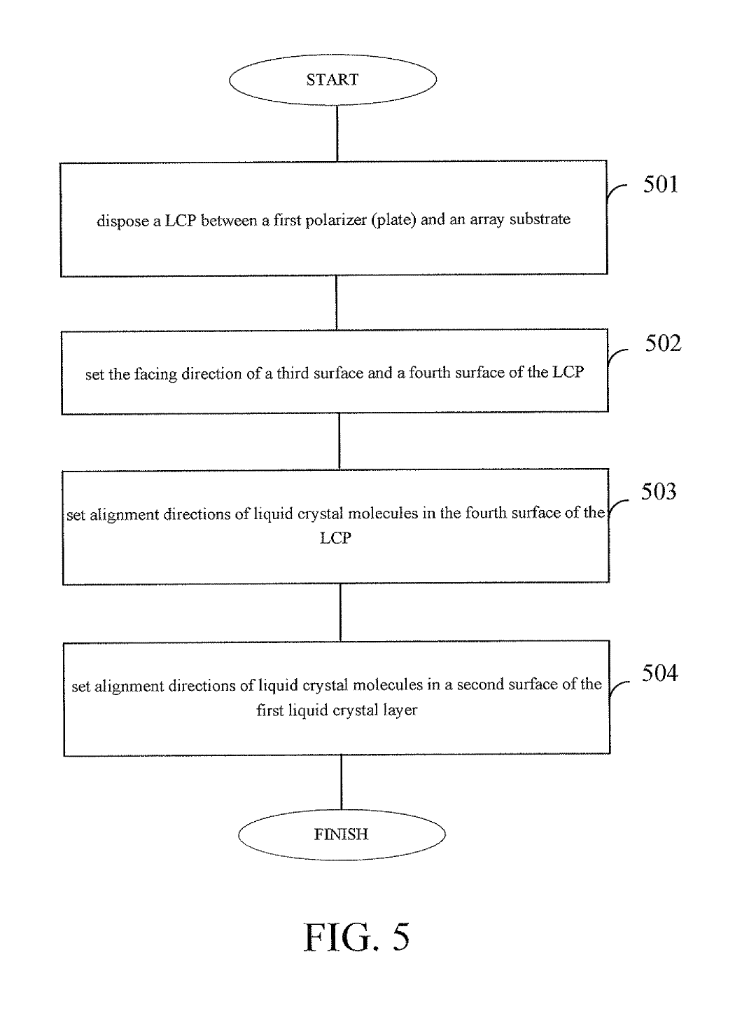

Referring to illustration shown in FIG. 5, FIG. 5 illustrates a flow chart of a LCD device manufacturing method according to the first embodiment of the present invention. In step 501, a LCP film 108 is disposed between a first polarizing plate 110 and an array substrate 106. In step 502, a facing direction between a third surface 107 and a fourth surface 109 of the LCP film 108 is set, substantially, the third surface 107 of the LCP film 108 is set facing to the array substrate 106, and the fourth surface 109 of the LCP film 108 is set facing to the first polarizing plate 110. In step 503, alignment directions of liquid crystal molecules located in the fourth surface 109 of the LCP film 108 are set, substantially the alignment directions of the liquid crystal molecules located in the fourth surface 109 are set parallel to the direction where the transmission axis of the first polarizing plate 110 is located. In step 504, alignment directions of liquid crystal molecules located in a second surface 105 of the first liquid crystal layer 104 are set so that the alignment directions of the liquid crystal molecules located in the second surface 105 of the first liquid crystal layer 104 are parallel to the alignment directions of the liquid crystal molecules located in the third surface 107 of the LCP film 108.

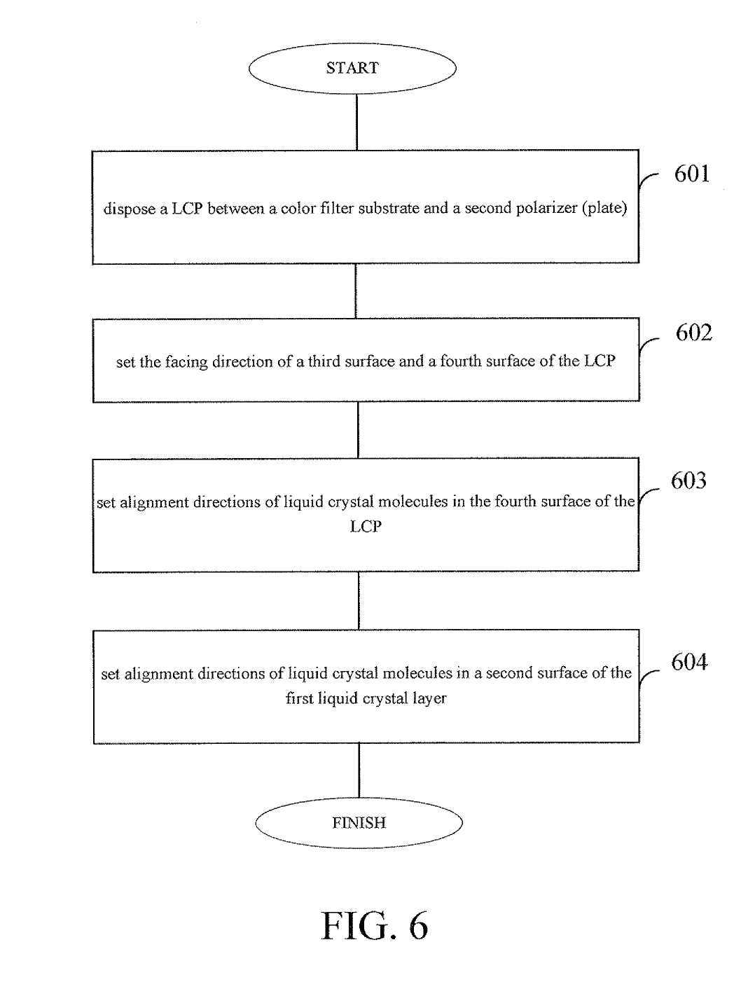

Referring to illustration shown in FIG. 6, FIG. 6 illustrates a flow chart of a LCD device manufacturing method according to the second embodiment of the present invention. In step 601, a LCP film 108 is disposed between a color filter substrate 102 and a second polarizing plate 101. In step 602, a facing direction between a third surface 107 and a fourth surface 109 of the LCP film 108 is set, substantially, the third surface 107 of the LCP film 108 is set facing to the second polarizing plate 101, and the fourth surface 109 of the LCP film 108 is set facing to the color filter substrate 102. In step 603, alignment directions of liquid crystal molecules located in the fourth surface 109 of the LCP film 108 is set, substantially, the alignment directions the liquid crystal molecules located in the fourth surface 109 are set parallel to the direction where the transmission axis of the first polarizing plate 110 is located. In step 604, alignment directions of liquid crystal molecules located in a first surface 103 of the first liquid crystal layer 104 are set so that the alignment directions of the liquid crystal molecules located in a first surface 103 of the first liquid crystal layer 104 are parallel to the alignment directions of the liquid crystal molecules located in the fourth surface 109 of the LCP film 108.

In the present invention, because the LCP film 108 is disposed between the first polarizing plate 110 and the array substrate 106, or the LCP film. 108 is disposed between the color filter substrate 102 and the second polarizing plate 101, the LCP film 108 of the present invention can effect the rotary polarization on the polarized light whereby the first liquid crystal layer 104 functions on allowing or prohibiting the polarized light passing through the first polarizing plate 110 and the second polarizing plate 101 to solve the technical problem of light leakage of the TN mode LCD device, basically. The present invention varies a display manner of the traditional TN mode LCD device, from displaying normally white state when the first liquid crystal layer 104 is applied without voltage and displaying the dark state when the first liquid crystal layer 104 is applied with voltage to displaying the dark state when the first liquid crystal layer 104 is applied without voltage and display the normally white state when the first liquid crystal layer 104 is applied with voltage, so that the light leakage phenomenon occurring on the LCD device can be avoided. Furthermore, the present invention retains the advantage of faster response as the traditional TN mode LCD device provided.

To sum up, the present invention has been disclosed as the preferred embodiments above, however, the above preferred embodiments are not described for limiting the present invention, various modifications, alterations and improvements can be made by persons skilled in this art without departing from the spirits and principles of the present invention, and therefore the protection scope of claims of the present invention is based on the range defined by the claims.

What is claimed is:

1. A liquid crystal display (LCD) device, comprising:
a backlight unit, a first polarizing plate, an array substrate, a first liquid crystal layer, a color filter substrate and a second polarizing plate, all of which are sequentially overlapped and assembled in integral, wherein the first liquid crystal layer comprises a first surface and a second surface, and alignment directions of liquid crystal molecules located in the first surface are vertical to alignment directions of liquid crystal molecules located in the second surface; and
a liquid crystal polymer (LCP) film disposed between the first polarizing plate and the array substrate and having a second liquid crystal layer disposed therein, wherein the alignment directions of the liquid crystal molecules located in the second liquid crystal layer are parallel to a plane where the LCP film is located, the second liquid crystal layer comprises a third surface and a fourth surface, alignment directions of the liquid crystal molecules located in the third surface are vertical to alignment directions of liquid crystal molecules located in the fourth surface, the second liquid crystal layer has the same phase difference with the first liquid crystal layer, liquid crystal molecules located in the third surface has the same alignment direction, liquid crystal molecules located in the fourth surface has the same alignment direction, and the alignment directions of the liquid crystal molecules are the directions where major axes of the liquid crystal molecules are located.

2. The LCD device of claim 1, wherein the third surface of the second liquid crystal layer faces to the first liquid crystal layer.

3. The LCD device of claim 2, wherein the fourth surface of the second liquid crystal layer faces to the first polarizing plate.

4. The LCD device of claim 3, wherein the alignment directions of the liquid crystal molecules located in the fourth surface of the second liquid crystal layer are parallel to a direction where a transmission axis of the first polarizing plate is located.

5. The LCD device of claim 4, wherein the alignment directions of the liquid crystal molecules located in the third surface of the second liquid crystal layer are parallel to the alignment directions of the liquid crystal molecules located in the second surface of the first liquid crystal layer.

6. A LCD device, comprising:
a backlight unit, a first polarizing plate, an array substrate, a first liquid crystal layer, a color filter substrate, and a second polarizing plate, all of which are sequentially overlapped and assembled in integral, wherein the first liquid crystal layer comprises a first surface and a second surface, and alignment directions of liquid crystal molecules located in the first surface are vertical to alignment directions of liquid crystal molecules located in the second surface; and
a liquid crystal polymer (LCP) film disposed between the first polarizing plate and the array substrate or between the color filter substrate and the second polarizing plate.

7. The LCD device of claim 6, wherein the LCP film have a second liquid crystal layer disposed therein, the alignment directions of the liquid crystal molecules located in the second liquid crystal layer are parallel to a plane where the LCP film is located, the second liquid crystal layer comprises a third surface and a fourth surface, and alignment directions of liquid crystal molecules located in the third surface are vertical to alignment directions of liquid crystal molecules located in the fourth surface.

8. The LCD device of claim 7, wherein the second liquid crystal layer has the same phase difference with the first liquid crystal layer.

9. The LCD device of claim 8, wherein if the LCP film is disposed between the first polarizing plate and the array substrate, the third surface of the second liquid crystal layer faces to the first liquid crystal layer, the fourth surface of the second liquid crystal layer faces to the first polarizing plate, the alignment directions of the liquid crystal molecules located in the fourth surface of the second liquid crystal layer are parallel to a direction where a transmission axis of the first polarizing plate is located, and the alignment directions of the liquid crystal molecules located in the third surface of the second liquid crystal layer are parallel to the alignment directions of the liquid crystal molecules located in the second surface of the first liquid crystal layer.

10. The LCD device of claim 8, wherein if the LCP film is disposed between the color filter substrate and the second polarizing plate, the third surface of the second liquid crystal layer faces to the second polarizing plate, the fourth surface of the second liquid crystal layer faces to the liquid crystal layer, the alignment directions of the liquid crystal molecules located in the fourth surface of the second liquid crystal layer are parallel to a direction where a transmission axis of the first polarizing plate is located, and the alignment directions of the liquid crystal molecules located in the fourth surface of the second liquid crystal layer are parallel to the alignment directions of the liquid crystal molecules located in the first surface of the first liquid crystal layer.

11. The LCD device of claim 7, wherein if the LCP film is disposed between the first polarizing plate and the array substrate, the third surface of the second liquid crystal layer faces to the first liquid crystal layer, the fourth surface of the second liquid crystal layer faces to the first polarizing plate, the alignment directions of the liquid crystal molecules located in the fourth surface of the second liquid crystal layer are parallel to a direction where a transmission axis of the first polarizing plate is located, and the alignment directions of the liquid crystal molecules located in the third surface of the second liquid crystal layer are parallel to the alignment directions of the liquid crystal molecules located in the second surface of the first liquid crystal layer.

12. The LCD device of claim 7, wherein if the LCP film is disposed between the color filter substrate and the second polarizing plate, the third surface of the second liquid crystal layer faces to the second polarizing plate, the fourth surface of the second liquid crystal layer faces to the liquid crystal layer, the alignment directions of the liquid crystal molecules located in the fourth surface of the second liquid crystal layer are parallel to a direction where a transmission axis of the first polarizing plate is located, and the alignment directions of the liquid crystal molecules located in the fourth surface of the second liquid crystal layer are parallel to the alignment directions of the liquid crystal molecules located in the first surface of the first liquid crystal layer.

13. A manufacturing method of a LCD device, the LCD device comprising a backlight unit, a first polarizing plate, an array substrate, a first liquid crystal layer, a color filter substrate, and a second polarizing plate, the first liquid crystal layer comprising a first surface and a second surface, and alignment directions of liquid crystal molecules located in the first surface being vertical to alignment directions of liquid crystal molecules located in the second surface, the manufacturing method comprising a step of sequentially overlapping and assembling the backlight, the first polarizing plate, the array substrate, the liquid crystal layer, the color filter substrate and the second polarizing plate in integral, wherein the LCD device further comprises a liquid crystal polymer (LCP); and
the manufacturing method further comprising the following steps of:
(A) disposing the LCP film between the first polarizing plate and the array substrate; or
(B) disposing the LCP film between the color filter substrate and the second polarizing plate.

14. The manufacturing method of LCD device of claim 13, wherein the LCP film have a second liquid crystal layer disposed therein, the alignment directions of the liquid crystal molecules located in the second liquid crystal layer are parallel to a plane where the LCP film is located, the second liquid crystal layer comprises a third surface and a fourth surface, the alignment directions of the liquid crystal molecules located in the third surface are vertical to the liquid crystal molecules located in the fourth surface.

15. The manufacturing method of LCD device of claim 14, wherein the second liquid crystal layer has the same phase difference with the first liquid crystal layer.

16. The manufacturing method of LCD device of claim 15, wherein if the LCP film is disposed between the first polarizing plate and the array substrate, the manufacturing method further comprises the following steps of:
(c1) setting the third surface of the second liquid crystal layer facing to the first liquid crystal layer;
(c2) setting the fourth surface of the second liquid crystal layer facing to the first polarizing plate;
(c3) setting the alignment directions of the liquid crystal molecules located in the fourth surface of the second liquid crystal layer being parallel to a direction where a transmission axis of the first polarizing plate is located; and
(c4) setting the alignment directions of the liquid crystal molecules located in the third surface of the second liquid crystal layer being parallel to the alignment directions of the liquid crystal molecules located in the second surface of the first liquid crystal layer.

17. The manufacturing method of LCD device of claim 15, wherein if the LCP film is disposed between the color filter substrate and the second polarizing plate, the manufacturing method further comprises the following steps of:
(d1) setting the third surface of the second liquid crystal layer facing to the second polarizing plate;
(d2) setting the fourth surface of the second liquid crystal layer facing to the first liquid crystal layer;
(d3) setting the alignment directions of the liquid crystal molecules located in the fourth surface of the second liquid crystal layer being parallel to a direction where a transmission axis of the first polarizing plate is located; and
(d4) setting the alignment directions of the liquid crystal molecules located in the fourth surface of the second liquid crystal layer being parallel to the alignment directions of the liquid crystal molecules located in the first surface of the first liquid crystal layer.

18. The manufacturing method of LCD device of claim 14, wherein if the LCP film is disposed between the first polarizing plate and the array substrate, the manufacturing method further comprises the following steps of:
(c1) setting the third surface of the second liquid crystal layer facing to the first liquid crystal layer;
(c2) setting the fourth surface of the second liquid crystal layer facing to the first polarizing plate;
(c3) setting the alignment directions of the liquid crystal molecules located in the fourth surface of the second liquid crystal layer being parallel to a direction where a transmission axis of the first polarizing plate is located; and
(c4) setting the alignment directions of the liquid crystal molecules located in the third surface of the second liquid crystal layer being parallel to the alignment directions of the liquid crystal molecules located in the second surface of the first liquid crystal layer.

19. The manufacturing method of LCD device of claim 14, wherein if the LCP film is disposed between the color filter substrate and the second polarizing plate, the manufacturing method further comprises the following steps of
(d1) setting the third surface of the second liquid crystal layer facing to the second polarizing plate;
(d2) setting the fourth surface of the second liquid crystal layer facing to the first liquid crystal layer;
(d3) setting the alignment directions of the liquid crystal molecules located in the fourth surface of the second liquid crystal layer being parallel to a direction where a transmission axis of the first polarizing plate is located; and
(d4) setting the alignment directions of the liquid crystal molecules located in the fourth surface of the second liquid crystal layer being parallel to the alignment directions of the liquid crystal molecules located in the first surface of the first liquid crystal layer.
